(19) United States
(12) Patent Application Publication
(10) Pub. No.: US 2017/0004261 A1
(43) Pub. Date: Jan. 5, 2017

(54) DEVICE AND METHOD FOR VISUALIZING TASKS

(71) Applicant: KONINKLIJKE PHILIPS N.V., Eindhoven (NL)

(72) Inventors: Youssef ABOU-HAWILI, Andover, MA (US); Johanna Maria DE BONT, Eindhoven (NL); Jurrien Carl GOSSELINK, Lichtenvoorde (NL); Kimberly Anne HOFFMAN, Salem, MA (US); John Francis HUMPHRYS, Needham (NL)

(73) Assignee: Koninklijke Philips N.V., Eindhoven (NL)

(21) Appl. No.: 15/122,192

(22) PCT Filed: Mar. 12, 2015
(86) PCT No.: PCT/IB2015/051796

§ 371 Date: Aug. 29, 2016

Related U.S. Application Data
(60) Provisional application No. 61/970,505, filed on Mar. 26, 2014.
(60) Provisional application No. 62/090,581, filed on Dec. 11, 2014.

(51) Int. Cl. G06F 19/00; G06F 3/0481; G06F 3/14; G06Q 10/06

(52) U.S. Cl. CPC G06F 19/327; G06Q 10/06311; G06F 19/322; G06F 3/04817; G06F 3/14

(57) ABSTRACT

A portable computing device (212) includes an analog clock device (244), a shift timer device (230), and a display device (214). The analog clock device (244) is configured to generate an analog clock face including concentric circles and task icons, each concentric circle including arranged icons of a selected task type. The shift timer device (230) is configured to identify a selected time window on the analog clock face. The display device (214) is configured to display the generated analog clock face. A display device 303 may display neonatal intensive care unit related information. Caregiver information, including information relating to a caregiver workload, may be displayed. Patient information, including vital sign information and event information, may be displayed.

The following relates generally to medical care checklists. It finds particular application in conjunction with clinically scheduled medications, tests, and procedures, and healthcare practitioner task organization, and will be described with particular reference thereto. However, it will be understood that it also finds application in other usage scenarios and is not necessarily limited to the aforementioned application.

Checklists help to improve the quality of medical care by decreasing human error under stressful conditions. For example, standardized order set checklists and daily check lists increase the use of best practices and compliance. A checklist of medications and delivery times to patients helps a healthcare practitioner ensure ordered medication is delivered to each patient on a timely basis. However, checklists are not widely used within the medical community.

A healthcare practitioner in a hospital, clinical care area, nursing home, or rehabilitation center may have responsibility for 15 or more patients. While the number of patients per practitioner may decrease with the type of care, such as an intensive care unit (ICU), the corresponding number of tasks may increase significantly. Checklists are typically paper and linear in format, e.g. lists of tasks. As the volume of a checklist increases and time needed to review each item and identify next steps increases, many checklists fall into disuse. In other words, time to manage the checklist becomes significant which detracts from the time to perform the tasks in the checklist, and the value of the list decreases.

Scheduling systems can provide task lists organized in formats such as Gantt charts, Pert charts, tabular lists, etc. However, the output is voluminous and does not consider the dynamic nature of the healthcare environment. Patients need tests, medications, and procedures each according to the patient's schedule. Although there is some flexibility in completing some tasks, tasks are constantly being added, changed, or removed in response to health conditions. Patients are admitted, transferred, and discharged. Planning/scheduling systems typically consider large scale project management, which focuses on efficient matching of resources to tasks over a project life cycle, e.g. the people needed to complete a project. Projects typically extend over days or weeks.

A healthcare practitioner in a shift has many small projects for a number of patients categorized as medications, tests, procedures, and protocols. For example, administrating medication to patient X at 10:00 a.m. includes identifying the type and amount of medication needed, e.g. checking the order and/or medical record of patient X, securing the medication from the source, e.g. pharmacy request, delivering the medication to the patient room, e.g. typically within ±x minutes of 10:00, administering the medication, e.g. identifying the injection site and injecting in the proper location, and recording the time of administration, e.g. entry to medical record. Follow-ups may be required. For pain medication, a patient may need to be questioned regarding pain level both 30 minutes before and 30 minutes after administration of the medication.

The number of steps or tasks in a clinical shift can be quite large, and can vary in time and effort for even similar tasks. Large numbers of tasks which change according to conditions produce large lists. Systems typically configure displays of large lists with scrolling, e.g. Google searches. The large lists make associating the task lists with the time available difficult to decipher, e.g. scrolling back and forth through the list to understand the time and nature of the tasks. Tasks lists from scheduling systems typically include a start time and/or an end time, and generally match a quantity of availability of a person with a quantity need for task completion, e.g. extend a task deadline according to resource availability. Clinical care operates differently. Clinicians are expected to perform the patient care tasks within the given time constraints. Clinicians dynamically adjust schedules, reordering tasks, deferring non-critical tasks, enlisting help from other team clinicians to address bottlenecks, etc., while continually cognizant of the time and any changes in tasks. Moreover, managing checklists to incorporate recommended practices for various situations with adjustments for local procedures or policies can become problematic.

Additionally, existing medical display and workflow tools focus on a patient with little thought given to caregivers.

The following discloses a new and improved shift organizer which addresses the above referenced issues, and others. The following also relates to a workflow tool that provides the best care while still taking into account the caregiver perspective.

In accordance with one aspect, a portable computing device includes an analog clock device, a shift timer device, and a display device. The analog clock device is configured to generate an analog clock face including concentric circles and task icons, each concentric circle including arranged icons of a selected task type. The shift timer device is configured to identify a selected time window on the analog clock face. The display device is configured to display the generated analog clock face.

In accordance with another aspect, a method of organizing tasks includes generating an analog clock face including concentric circles and task icons, each concentric circle including arranged icons of a selected task type. A selected time window on the analog clock face is identified. The generated analog clock face is displayed.

In accordance with another aspect, a computing device includes one or more processors and a display device. The one or more processors are configured to identify a time window which includes a time duration of at least one work shift, and receive tasks corresponding to at least one patient and the identified time window. The processors are further configured to organize the received tasks according to medical task type which includes at least one of tests, medications, or procedures, and select icons for each organized task according to the task type and quantity of tasks within a predetermined time period. The display device is configured to display at least one of: (i) the selected icons in concentric circles of an analog clock face; or (ii) a caregiver section comprising an identification information section and a workload section, and a patient section comprising a patient vital sign section and a patient timeline section.

In accordance with another aspect, a method of organizing and rescheduling tasks in an adaptive, patient-centric workflow on a display device is provided, including: displaying a caregiver section comprising an identification information section and a workload section; and displaying a patient section comprising a patient vital sign section and a patient timeline section.

One advantage is tasks are organized according to a shift time window.

Another advantage resides in summarizing tasks in a single display.

Another advantage resides in display representations of different types of tasks and task priorities in a single display.

Another advantage resides in indicating task densities and relative timeframes.

Another advantage resides in a display configurable by practitioner.

Another advantage resides in the relative future and historical timeframe shift configurations.

Another advantage resides in indicating the priorities of specific tasks.

Another advantage resides in easy handover of patients or tasks between caregivers. For example, if a caregiver leaves, the caregiver's tasks may be reassigned to another caregiver. The system logs everything and marks events as completed so there is no need for caregivers to inform each other of completed events. This results in better and more efficient care.

Another advantage resides in adaptive workflow. For example, as a patient's needs change and tasks are completed, events may be updated, added, or removed.

Another advantage resides in better working experience for the caregivers. Using features of a device described herein, caregivers can fully focus on their actual task and the device described herein can help them give the best possible care by looking at the patient's needs. The combined view of the vital signs (icon), schedule view and workload makes it easier for the caregiver to plan certain tasks. The overview of the work and the well-being of the patient becomes much clearer.

Another advantage resides in data collection. The data that is collected and is used to generate the adaptive planning can be collected for analysis and developing new products or improving the current product-portfolio.

Still further advantages will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

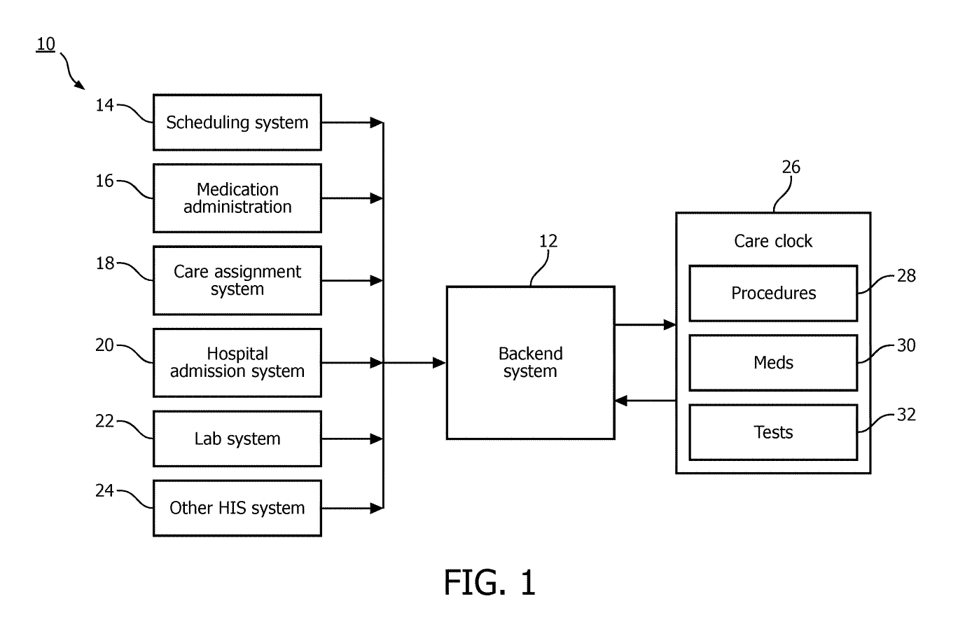

FIG. 1 diagrammatically illustrates an embodiment of a patient care clock system.

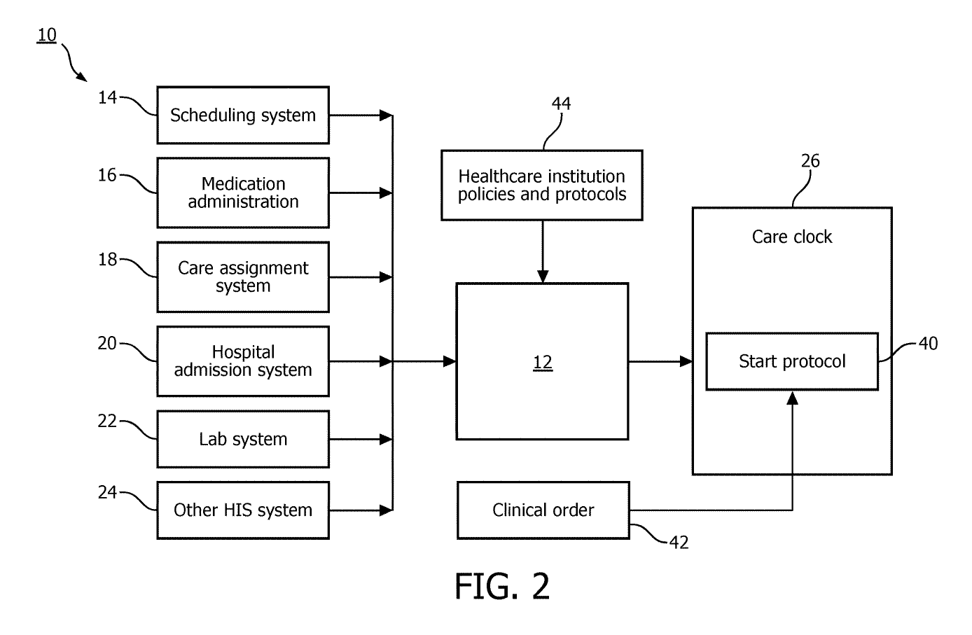

FIG. 2 diagrammatically illustrates another embodiment of the patient care clock system.

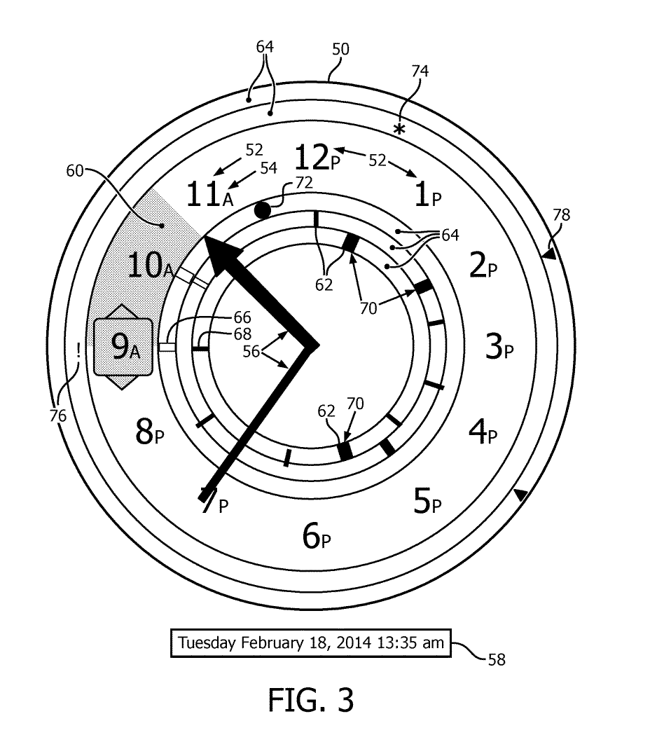

FIG. 3 schematically illustrates an embodiment of an arranged analog clock face display.

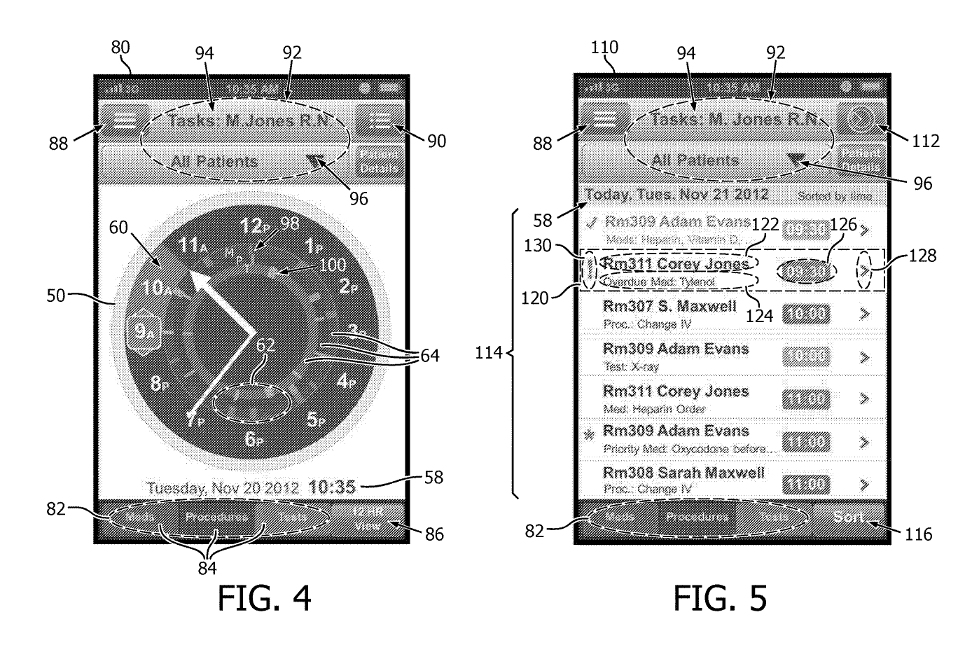

FIG. 4 illustrates an exemplary arranged analog clock face display on a portable computing device display.

FIG. 5 illustrates an exemplary task checklist display on a portable computing device display.

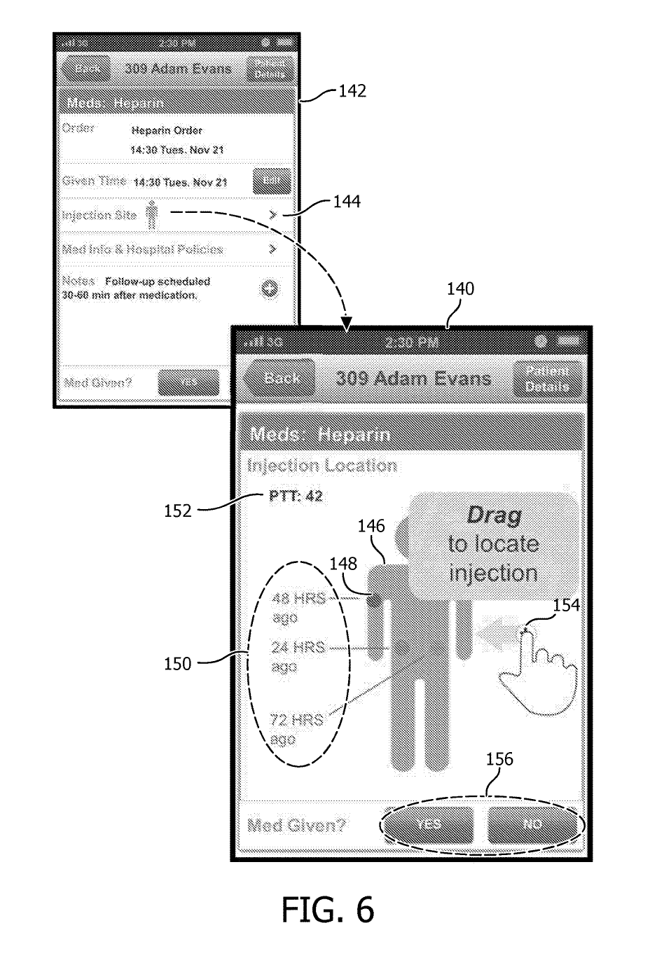

FIG. 6 illustrates an exemplary medication site injection display on a portable computing device display and a corresponding exemplary display of a medication order display.

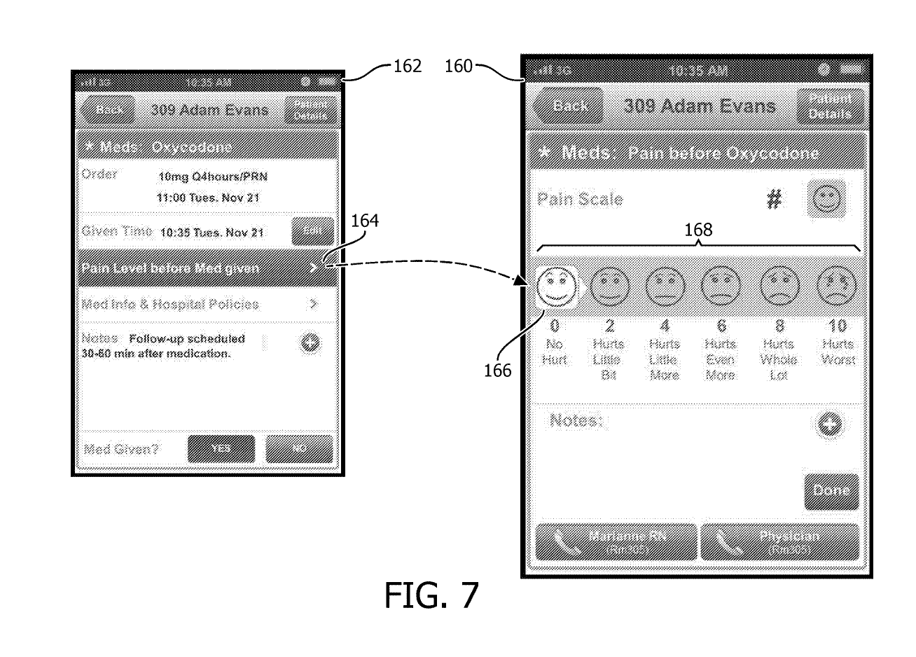

FIG. 7 illustrates an exemplary selectable pain scale display on a portable computing device display and a corresponding exemplary medication order display.

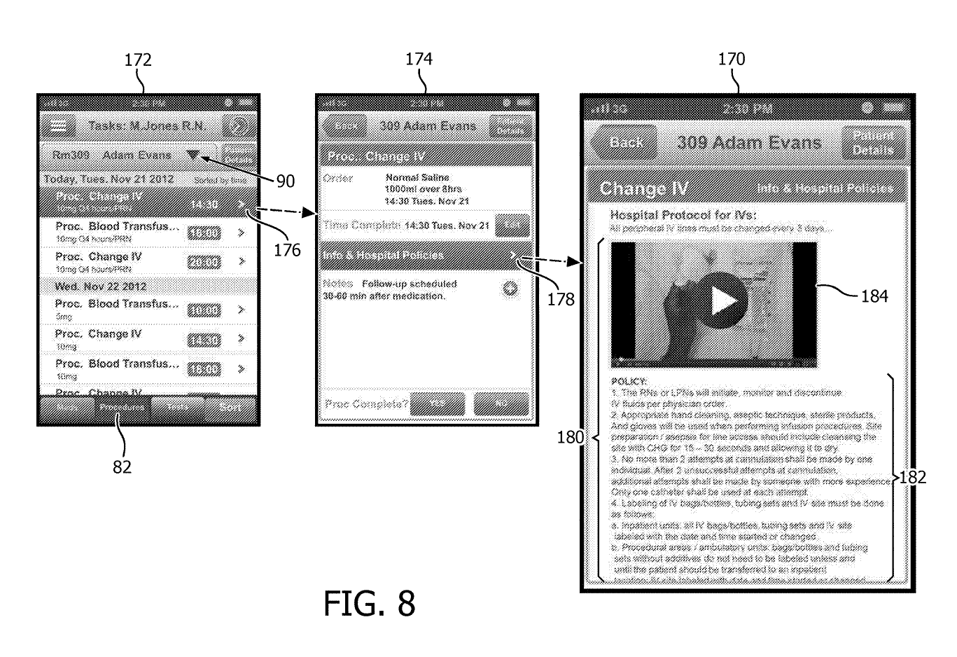

FIG. 8 illustrates an exemplary site instruction display on a portable computing device display and a corresponding exemplary checklist task display and an exemplary task detail display.

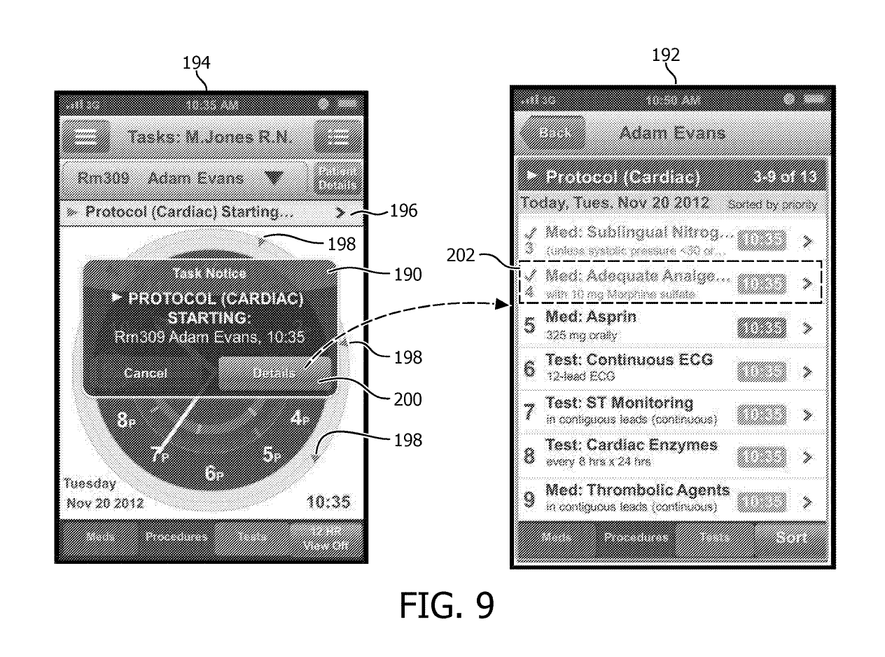

FIG. 9 illustrates an exemplary protocol initiation display on a portable computing device display and a corresponding exemplary protocol checklist display.

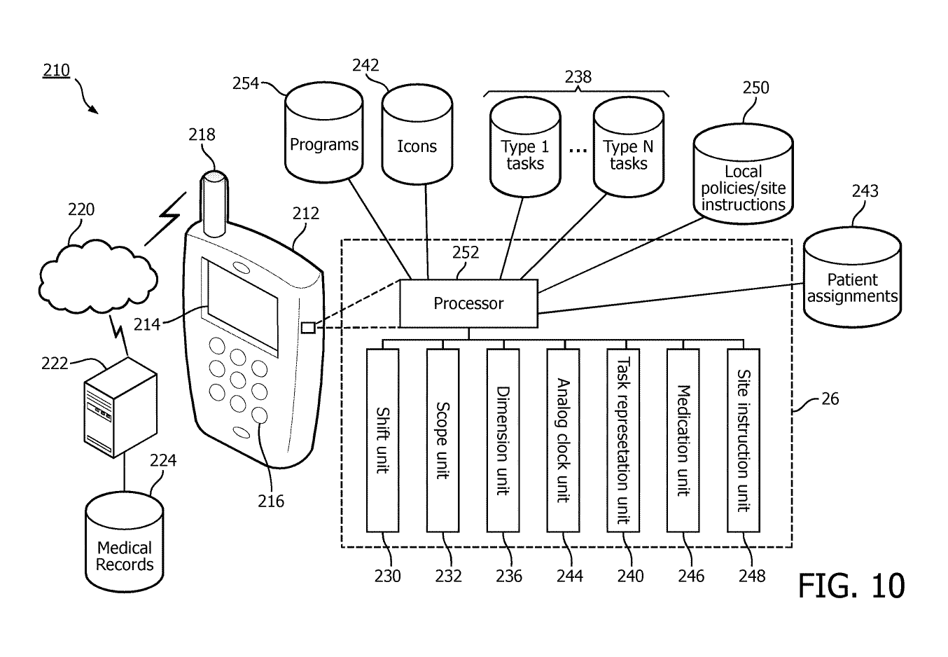

FIG. 10 schematically illustrates another embodiment of the patient care clock system.

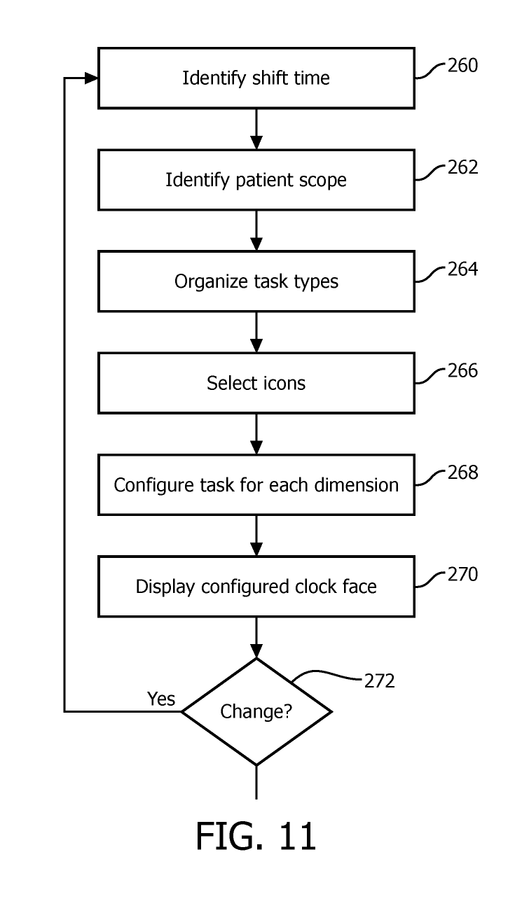

FIG. 11 flowcharts an embodiment of organizing a shift.

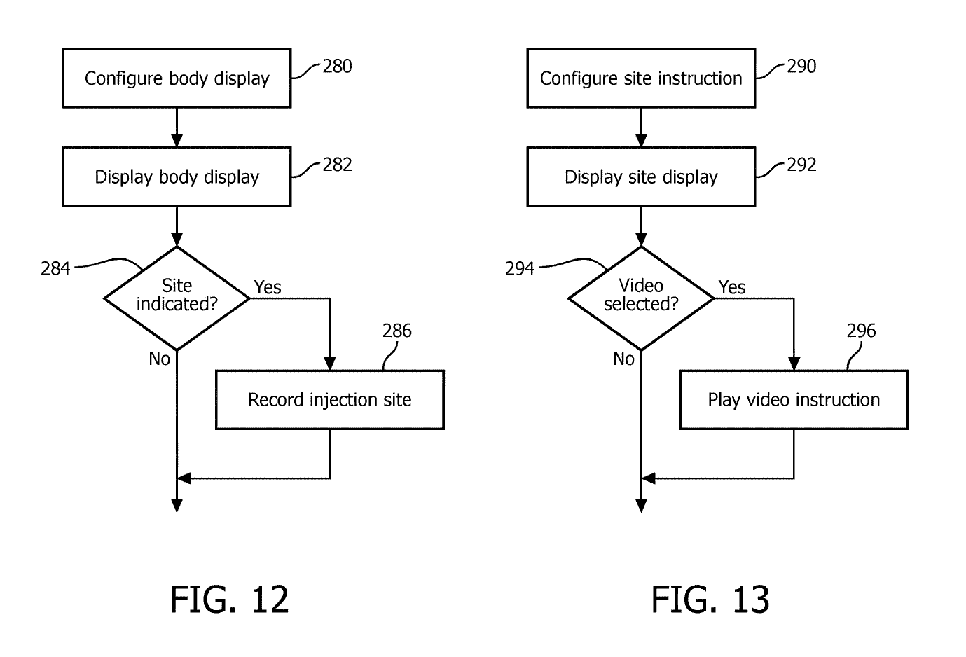

FIG. 12 flowcharts an embodiment of medication injection site tracking.

FIG. 13 flowcharts an embodiment of site instruction.

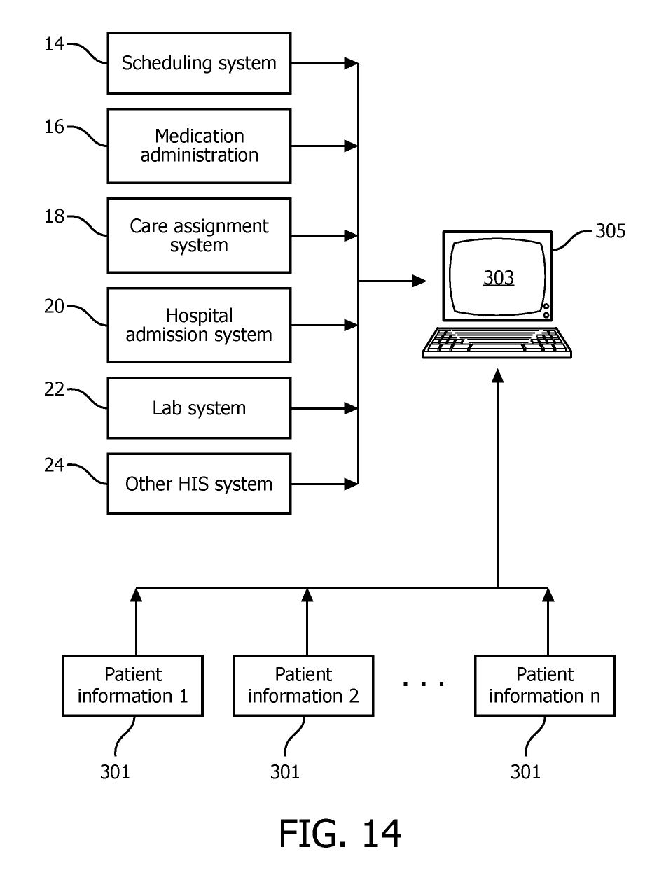

FIG. 14 diagrammatically illustrates an embodiment.

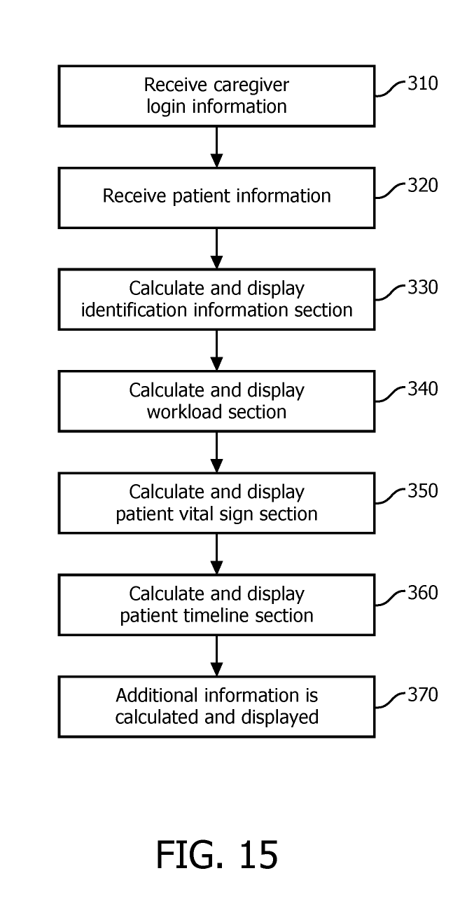

FIG. 15 flowcharts an embodiment of a display.

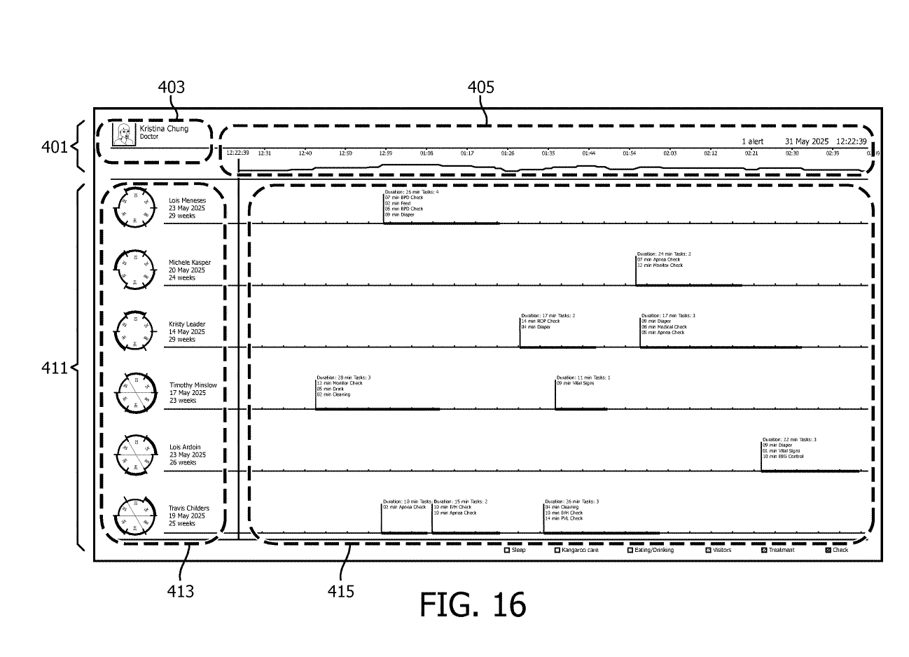

FIG. 16 illustrates another embodiment of a display.

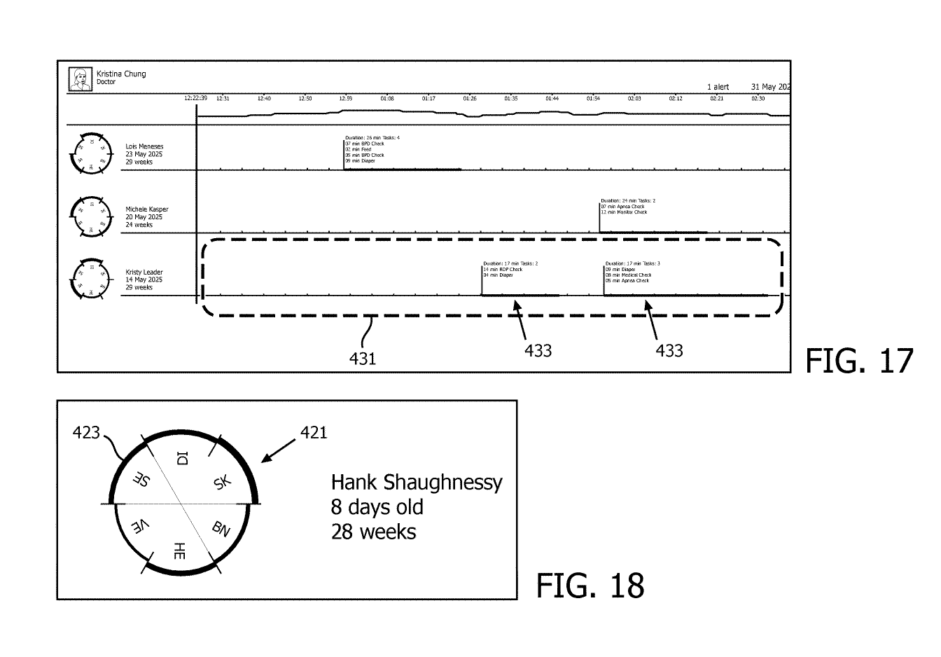

FIG. 17 illustrates another embodiment of a display.

FIG. 18 illustrates an aspect of displaying patient vital sign information.

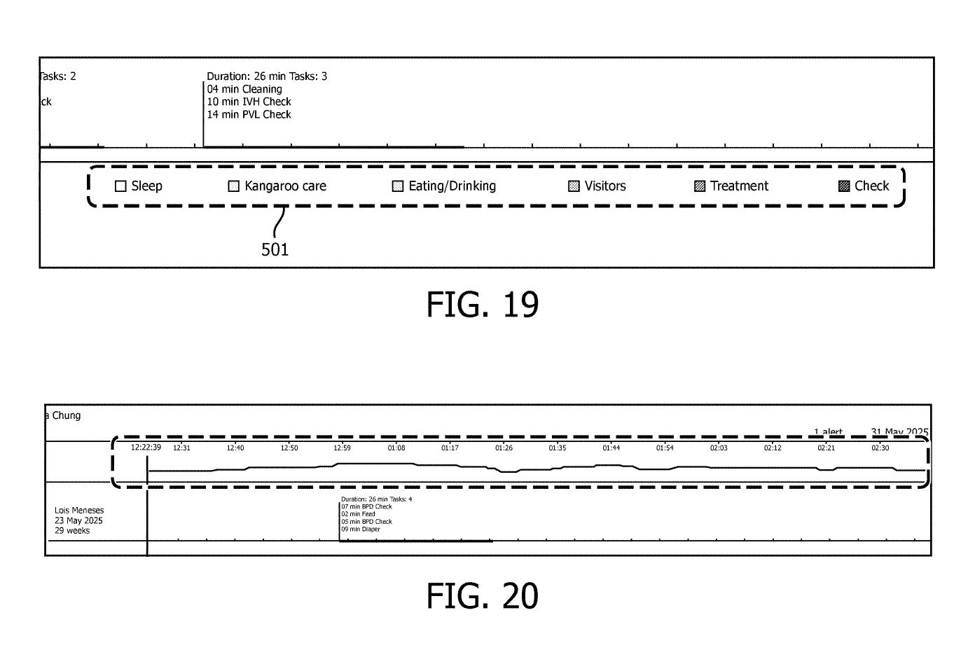

FIG. 19 illustrates an embodiment of a display including toggle buttons.

FIG. 20 illustrates another embodiment of a display.

With reference to FIG. 1, an embodiment of a patient care clock system 10 is diagrammatically illustrated. The system 10 includes a backend system 12 which receives healthcare information concerning patients and healthcare practitioners, such as Healthcare Level 7 (HL7) messages from one or more of a scheduling system 14, medication administration system 16, care assignment system 18, hospital admission system 20, lab system 22, or other hospital information system (HIS) 24. For example, the scheduling system 14 provides shift schedules for nurses and other caregivers. The shift schedules include the time period each healthcare practitioner is scheduled to be in a location, e.g. 8 am to 4 pm in location 7. In another example, the medication administration system 16 provides the prescribed medications for each patient and the schedule for the administration of each medication, e.g. medication X for patient Y dose Z every Q hours. In another example, the Care Assignment System 18 provides the assignment of patients to each healthcare practitioner, e.g. patients 1-8 assigned to nurse C or patient locations 1-8 assigned to nurse C. In another example, the hospital admission system 20 provides patient information and location information, e.g. Mary Jones located in room 6. In another example, the lab system 22 provides tests ordered for patients, e.g. x-ray ordered for Adam Smith, blood test ordered for Mike Jones, etc. Other systems can participate in supplying information to the backend system which will vary depending on the healthcare facility. The backend system aggregates and manages the information received from the various systems 14, 16, 18, 20, 22, 24 and supplies selected information to a front end system or care clock 26 based on the assigned healthcare practitioner.

The care clock 26 interfaces with the assigned healthcare practitioner, and displays one or more care tasks, such as performing a medical procedure 28, administering a medication 30, or performing a medical test 32. The care tasks include tasks for one or more patients based on the assigned patients. Each task includes a task type such as procedure, medication, or test. The task includes patient identity and/or patient location information, the scheduled time for the task, and the task type. The care clock 26 receives the task information from the backend system 12. The care clock 26 receives updates from the healthcare practitioner or caregiver concerning the status of the assigned care tasks and forwards the information to the backend system 12. The backend system 12 updates the appropriate system based on the type of update. For example, a time of medication administration is recorded in an electronic patient medical record and/or the medication administration system.

The backend system 12 and the care clock 26 of each healthcare practitioner operate in a cooperative configuration, such as peer to peer computing and/or client server computing configuration. The backend system 12 includes a configured computer server and the care clock 26 includes a configured portable computing device. The processing and storage is distributed between the backend system 12 and each care clock 26.

With reference to FIG. 2, another embodiment of the patient care clock system 10 is diagrammatically illustrated. Illustrated is a protocol scheduling 40 which includes scheduling of one or more tasks according a protocol, such as rule out myocardial infarction, rule out stroke, etc. The protocol is initiated by a clinician order 42 for one patient and includes one or more of procedures, medications, and tests according to a fixed schedule determined by a healthcare institution defined policies and protocols 44. A notice is delivered to the care clock 26 of the healthcare practitioner assigned to the patient. As each task is completed according to the protocol, task data is returned to the backend system which includes a decision engine. The decision engine receives the task data and schedules the steps of the protocol. The protocol can include multiple paths and the decision engine modifies the scheduled tasks accordingly. For example, the result of a first task includes a test which rules out a stroke or the result is inconclusive and additional tasks of medications and a second test are scheduled.

With reference to FIG. 3, an embodiment of the care clock 26 which includes an arranged analog clock face 50 display is schematically illustrated. The analog clock face 50 includes hour indicators 52 in a circular arrangement, e.g. numeric representations of the hours in a circle. The hour indicators 52 include an AM/PM designation 54 in a 24 hour window relative to the current time, e.g. “A” for ante meridiem or morning, and “P” for post meridiem or afternoon. The analog clock face is configured to display a 12 hour window. The time window is indicated relative to hour and minute indicators 56, e.g. large and small hands. The time is displayed as a 24-hour date time 58. The time window is relative to the 24-hour date time. The time window can include a historical time period with a historical indicator 60 in the clock face, such as colored or shaded area. As the historical period is increased, e.g. by dragging the trailing end (earliest time) counterclockwise, the future period is reduced such the time window remains displaying 12 hours. For example, with a time period of 10:35 and a historic time period of 1 hour and 35 minutes, the future time period is reduced from 12 hours to 10 hours and 25 minutes. The 24-hour date time indicator can be advanced, such as by the hour, day, shift, or a specified interval or a date and a time. The time window displayed starting with the hour and minute indicators 56 is relative to the 24-hour date time 58.

The analog clock face 50 includes a multi-dimensional arrangement of task indicators or icons 62. Each dimension is represented with a concentric circle or band 64. The concentric circles are located either inside and/or outside the hour indicators 52. The concentric circles located inside the hour indicators include tasks of a task type, such as medications, tests, procedures, protocols, and the like. The concentric circles located outside the hour indicators can include high priority notification, outstanding task notification, protocols, and the like. For visual clarity, the concentric circles 64 can be outlined, color coded, spaced, and/or shaded.

Tasks are represented in concentric circle of the corresponding task type with icons 62. Selected icons can represent task status. For example, one icon 66 is used for completed tasks, such as shaded or outlined only, and another icon 68 is used for uncompleted tasks, such as filled or colored. In one embodiment, completed tasks appear only on the clock during the historic time frame. Selected icons 70 can represent quantity of tasks in a given time period, such as doubled icons for multiple tasks. Other selected icons 72 can represent related follow-up tasks, such as a circle. Selected icons can represent a high priority notification 74, such as an asterisk. Selected icons 76 can represent outstanding or overdue tasks, such as an exclamation point. Selected icons 78 can represent fixed tasks in time, such as triangles. An example of fixed tasks is a protocol to rule out heart attack, or stroke. The fixed tasks can include a combination of medications, tests, and/or procedures to be performed according to a predetermined schedule.

The configured analog clock face 50 is arranged dynamically. The clock face is arranged based on event notification, e.g. as tasks are added, changed, or removed, and/or based on a predetermined time polling time interval. The clock face can be further arranged with a time displacement, such as a changing of a shift, the future date and time, or the historic time indication. The configured analog clock face in a single visual display provides a healthcare practitioner a concise summary of the relative time frame of different task types to be performed during a shift in a multi-dimensional format.

With reference to FIG. 4, an exemplary arranged analog clock face 50 on a portable computing device display 80 is illustrated. The arranged analog clock face 50 includes concentric circles 64 which are color coded and matched to control buttons 82. The control buttons 82 are similarly color coded and control switching on/off or toggling the presence of each task type 84, such as meds or medications, procedures, or tests. For example, selecting the meds control button toggles the presences of the concentric circle and icons within the task type of medications. A control button 86 resets the historic display 60, e.g. resets the time window to current time forward 12 hours and removes historic information from the display. In one embodiment, the control button toggles to turn on the historic display 60 with a preferred or pre-determine time value, e.g. 1 hour prior. In one embodiment, an overdue item in the history section remains until the task is completed and prevents removing the historical area.

The display 80 includes a menu control button 88. The menu control button 88 directs the portable computing device to configure and display a menu display either as a pop-up display overlay or as a separate display. A checklist control button 90 directs the portable computing device to configure and display a corresponding checklist formatted display as shown in FIG. 5. The display includes the 24-hour date time 58 which can be displayed in a 24 hour format or a 12 hour format, e.g. with am and pm suffix.

The display 80 includes scope control 92. The scope control 92 includes identification of an assigned person 94, e.g. the healthcare practitioner responsible for completing the assigned tasks and/or patient assignments. The assigned person 94 is established on the portable computing device through configuration and/or the preferences display, e.g. login information, user identity, device identity, and the like. The scope control 92 includes a local control 96, such as a drop down box. The local control 96 operates to select all assigned patients, patient collectives, or patients individually. The scope control controls the arranged analog clock face to display tasks within the specified scope, e.g. assigned person and local control selection. With all patients selected with the local control 96, the icons represented in concentric circles 64 represent the number of patients with tasks in the time period assigned to the healthcare practitioner. Again, the circles each represent one of meds, procedures, or tests tasks. For example, a single bar icon 98 represents a task for single patient, and a double bar icon 100 represents tasks for multiple patients. In one embodiment, the double bar icon 100 represents the number of tasks. With one patient selected with the local control 96, the icons located in the concentric circles 64 represent the number of tasks for the selected patient in the time period. For example, with the local scope control set to include all patients, a double bar icon represents tasks for two or more patients, e.g. Mary Smith and Joe Jones, and with the local scope control set to include one patient, a double bar icon represents multiple tasks for the one patient, e.g. two medications for Mary Smith. The representation is configurable or is set in the preferences display.

The icons 62, in one embodiment configured with a touch screen input, drill down to the task details. For example, the healthcare practitioner select one icon with a screen touch to display the details of patients and/or tasks represented by the selected icon, e.g. patient information and related task and/or task details.

With reference to FIG. 5, an exemplary task checklist display 110 of the portable computing device display is illustrated. The task checklist display is invoked by the task list control button 90 discussed in regard to FIG. 4. The task checklist display 110 includes an analog clock face display control button 112 which returns the portable computing device display to the analog clock face display 80. The display 110 includes the 24-hour date time 58. The scope control 92 and the task type control buttons 82 operate to control the display scope of patient and/or task detail list 114. For example, the tasks related to all patients are shown with the local scope control set 96 to all patients, and all the task type control buttons 82 set to enable. The patient/task detail list 114 is scrollable, e.g. finger swipe up or down to scroll. The patient/task detail list 114 order is controlled by a sort control button 116, which is configured upon selection to reorder the patient/task detail list 114. The sort control button 116 selection in one embodiment displays a sort splash screen which enables various sort orders, e.g. by patient and/or task attributes.

Each patient/task detail 120 in the task list is adjustable, e.g. system, site, user preferences, context, etc. The patient/task detail 120 includes patient attributes 122, such as a room or location, a patient name, etc. The patient/task detail 120 includes task attributes 124, such as the task type, a task description, and the like. The patient/task detail 120 includes a schedule time 126 and a drill down indicator 128. The patient/task detail 120 can include a status indicator 130, such as completed, high priority, and the like.

With reference to FIG. 6, an exemplary medication site injection display 140 on a portable computing device display and a corresponding exemplary display of a medication order display 142 are illustrated. The medication order display is accessed by the healthcare practitioner through selection of the drill down indicator 128 or the area indicated by the drill down indicator described in reference to FIG. 5. The medication site injection display 140 is accessed by the healthcare practitioner through an injection site drill down indicator 144.

The medication site injection display 140 includes a FIG. 146 representative of a human body with injection sites 148 visually indicated in reference to the figure representation. The injection sites 148 include labels 150 which provide the time or approximate time, e.g. time rounded, elapsed since the corresponding injection. In another embodiment, the time display can include other time formats such as actual date and time. In another embodiment, the label format is configured through site configuration, user preferences, and the like. The display 140 includes related medical test results 152.

The display 140 includes a selection icon 154 configured to allow the healthcare practitioner to select a new injection site, e.g. drag and drop on new site represented on the FIG. 146. Medication confirmation control buttons 156 are configured to provide confirmation of medication administration to the patient, record the time, etc.

With reference to FIG. 7 an exemplary selectable pain scale display 160 on a portable computing device display and a corresponding exemplary medication order display 162 are illustrated. The medication order display 162 includes a pain level drill down indicator 164 configured to allow a healthcare practitioner to select the pain scale display 160.

The pain scale display includes a pain scale indicator 166 configured to indicate the amount of pain the patient is suffering at a point in time, e.g. 30 minutes before medication, 30 minutes after medication, etc. The pain scale indicator operates with a sliding scale, e.g. drag and drop at pain level on a pain scale 168. The pain scale can be adapted to different patient requirements, such as age level and/or patient entry. For example, a young patient or non-verbal patient can be shown the display of facial expressions and indicate the selection directly. In another example, the scale can be changed to different languages or other formats.

With reference to FIG. 8, an exemplary site instruction display 170 on a portable computing device display and a corresponding exemplary task checklist display 172 and a task detail display 174 are illustrated. The task checklist display 172 local scope control 90 is configured to display patient/task details for procedures. The procedures are configured for display with the corresponding task type control button 82 for procedures set to the “on” configuration as described in reference to FIG. 4. The procedure task type control button changes the patient/task details to procedures. The procedure for changing an IV at 14:30 is shown in a selected configuration, e.g. shaded. The task detail display 174 is configured to display by selection of an area 176 indicated with the drill down indicator.

The task detail display 174 is configured to display details of the task, e.g. procedure to change an IV, such as the order, the scheduled time, notes. The task detail includes a site instruction drill down indicator corresponding to a label of information and hospital policies 178.

The local site instruction display 170 includes site procedures, protocols and/or policies 180 related to the task or protocol. The site procedures/policies are scrollable. The site policies 182 are written in text. Key practices or highlights can be visually separated for effect, e.g. a message that all peripheral IV lines must be changed every 3 days. A video indicator 184 is shown configured to display a video of instructions related to the task. For example, selecting the video indicator streams a video of instructions for changing an IV. In other embodiments, the instructions can include text, pictures, illustrations, and the like.

With reference to FIG. 9, an exemplary protocol initiation display 190 on a portable computing device display and a corresponding exemplary protocol checklist display 192 are illustrated. The protocol initiation display includes a description of the initiated protocol and patient information, such as patient name, room location, etc. The protocol initiation display is shown as an overlay or splash display on another arranged analog clock face display 194. The arranged analog clock face display 194 includes a status notice 196 for the initiated protocol. The arranged clock face display includes icons 198 in a concentric circle representing scheduled tasks of the initiated protocol, such as rule out heart attack or myocardial infarction (MI), rule out stroke, etc. A protocol detail button 200 is configured to display the protocol checklist display 192 when selected by the healthcare practitioner.

The protocol checklist display 192 includes the medication, procedures, and tests in the patient/task display format. The display is scrollable. The protocol checklist display scope control includes the patient and the initiated protocol. For example, the patient/task list scope control limits the patient/task detail 202 for medications, procedures, and tests as related to the protocol for the patient. The patient/task detail includes a step or order for the protocol.

With reference to FIG. 10, another embodiment of a patient care clock system 210 is schematically illustrated. The system 210 includes a portable computing and display device 212 such as a handheld, body mounted, or cart mounted computing device, and the like. For example, the portable computing device in one embodiment is a head mounted device, and in another embodiment is a wrist mounted device. The portable computing device 212 includes a display device 214 and one or more input devices 216. In one embodiment, the display device includes a touch screen input device.

The portable computing device 212 includes one or more wireless communication devices 218 configured to provide wireless communications, such as cellular communications, 802.x communications, and the like. The wireless communications include data and/or voice transmission capabilities. For example, through a network 220, the portable computing device accesses a server 222 or remote system to receive patient scheduling information 224, such as described in references to FIGS. 1 and 2.

The portable computing device includes a shift timer device or means 230, such as a dedicated or shared programmable device, configured to identify a selected time window. The time window includes either a 12 hour window or a work shift window, e.g. 6 hours, 8 hours, 12 hours, etc. For example, the 12 hour window includes a range of up to 11 hours historical time with the remainder prospective or future time. In another example, the 12 hour window includes a future time interval, such as the same shift for the next day. In another example, the time interval is a dynamic interval with changes with current time, e.g. current time plus 12 hours. The shift time device 230 uses an internal clock or a system level clock to generate the 24-hour date time 58 described in reference to FIG. 3 and FIG. 4 and a system or user preference or default to identify the time window relative to the 24-hour date time. The system or user preference can include the work shift of the healthcare practitioner. The identified time window can be further modified by input, such as by the healthcare practitioner to identify the future work shift or the historical time period and adjust the generated 24-hour date time 58.

The portable computing device includes a scope device 232 or other means such as a dedicated or shared programmable device, configured to retrieve tasks according to a scope and the identified window. The scope device 232 identifies the scope based on patients assigned to the healthcare practitioner. For example, tasks are associated with patients according to the patient medical record, the patient emergency room record, the doctor's order system, the initiated protocol and the like. The patient assigned to the healthcare practitioner can be stored in a memory 234 locally or at the system level, e.g. on the server. The tasks are associated with the healthcare practitioner by way of the assigned patients. The scope includes the local scope 96 described in reference to FIGS. 4 and 5. For example, the healthcare practitioner via one input device modifies the local scope from all assigned patients to a single patient. The scope is applied to the tasks of the associated with the healthcare practitioner to retrieve the tasks either from local storage or system level storage, e.g. storage associated with the server 222.

A dimension unit 236 or other means of the portable computing device, such as a dedicated or shared programmable device, organizes the retrieve tasks according to the task type. For example, the tasks are arranged according to medications, procedures, and tests. The arrangement can include one or more of a database organization, sort processing, and/or local or system level storage 238 or memory. In one embodiment, the task types include high priority notifications and/or late task notifications. The organization includes modifications based on the healthcare practitioner input. For example, with the control buttons 82 described in reference to FIGS. 4, 5, and 8, one or more task types can be removed or added.

A task representation device 240 or other means of the portable computing device, such as a dedicated or shared programmable device, selects icons for each organized task. The task representation device selects icons from a memory or data store 242 of icons according to the task type and quantity of tasks represented. The selection can include construction of an icon and/or modification of an existing or retrieved icon from the icon memory 242. For example, with medications for a scope of all patients and multiple tasks outstanding within a predetermined time interval, an icon is constructed using encapsulated program code for a double wide rectangular bar and color filled blue. In another example, with an initiated protocol, bar icons are selected and color filled for each of the medications, test, and procedures tasks associated with the initiated protocol and the color filled differently for medications, tests, and procedures, and triangle icons are selected for the protocol task type.

The portable computing device 212 includes an analog clock device 244, such as a dedicated or shared programmable device, configured to arrange the selected icons in concentric circles of the analog clock face display as further described in reference to FIG. 3. Each concentric circle includes arranged icons of a task type. The arrangement of concentric circles can be modified by the control buttons 82. For example, the configured display includes the medication concentric circle and selected icons for the medication tasks with the medication control button in the “on” position, and the configured display does not include medications task icons with the medication control button in the “off” position. The display device 214 displays the arranged display.

A medication device 246 or other means of the portable computing device, such as a dedicated or shared programmable device, constructs a display representation of a body with prior injection sites indicated. As described in reference to FIG. 6, the display visually indicates on the figure representation of the patient body the prior sites and labels each site. The medication unit can receive the practitioner input indicating a new injection site. The medication unit records the new injection site by storing locally and/or forwarding the indicated site to the server 222 and the time of medication administration.

A site instruction device 248 or other means of the portable computing device, such as a dedicated or shared programmable device, receives site instructions for a test, procedure, or medication and configure a display which includes the received site instructions as described in reference to FIG. 8. The site instructions 250 in FIG. 10 are stored locally and/or retrieved from the server 212. The stored site instructions can include text, photographs, illustrations, and/or video, and the policies concerning the scheduled task.

The portable computing device includes one or more processors 252. The various devices 230, 232, 236, 240, 244, 246, and 248 are suitably embodied by one or more processors 252 or a data processing device, such as the electronic, optical, and/or mechanical processor or processing device of the portable computing device 212, by a network-based server computer operatively connected with the portable computing device 212 by the network 220, permanently programmed field programmable gate array (FPGA), or so forth. Moreover, the disclosed retrieval, selection, organization, arrangement and display construction techniques are suitably implemented using a non-transitory storage medium storing instructions (e.g., software) 254 readable by an electronic data processing device and executable by the electronic data processing device to perform the disclosed techniques.

With reference to FIG. 11, an embodiment of organizing a shift is flowcharted. In a step or module 260, a selected time window is identified. The time window includes a 12 hour time window and/or a work shift window. The work shift window is a time interval of scheduling tasks for viewing by the practitioner up to 12 hours. The time window can include a range of up to 11 historical hours of scheduled tasks. The scheduled tasks can be completed or uncompleted. The time window is selectable or adjustable. For example, the practitioner can adjust or extend the analog clock face to expose the historical time period by selecting and dragging the shaded clock face.

In a step or software module 262, tasks are retrieved according to the scope and the identified time window. The scope includes patients assigned to the practitioner or user of the portable computing device and includes a local scope control, which selects tasks for a single patient or other defined collection. For example, the local selection can include patients with high acuity, or selection of one or more patients individually. The tasks are associated with patients and received from a doctor's order, patient medical record, emergency patient medical record, a protocol, and the like.

In a step or software module 264, the retrieved tasks are organized according to task type. For example, tasks are organized by medical tests, medications, medical procedures, protocols, and the like. One task can relate to multiple task types. The organization specifies the task types and relates each task to one or more task types, e.g. medication and high priority.

Icons are selected for each organized task or patient/task in a step or software module 266. One icon can represent multiple tasks or tasks for multiple patients in a given time interval. For example, in a n minute interval, where n is duration in minutes to be represented by one icon, a single task can be represented with a first icon, multiple tasks for a single patient with a second icon, and multiple patients each with a task represented with a third icon, etc. The selected icon can represent a quantity of tasks which include either one task for a multiple patients or multiple tasks for a single patient dependent upon the scope control, e.g. context dependent.

The selected icons are arranged in concentric circles of an analog clock face display in a step or software module 268. The tasks for each task type are arranged in the concentric circle corresponding to the task type. For example, a concentric circle of a first task type includes icons of the first task type, and a second concentric circle of a second task type includes icons of the second task type. Each icon is placed in the circular arrangement according to the scheduled time corresponding to the position on the analog clock face.

The arranged display is displayed on the display device 214 in a step or software module 270. The arranged display is refreshed by an event and/or by a predetermined time interval, in a decision step or software module 272. For example, the display is updated based on elapsed time, receipt of an additional scheduled task, practitioner input, and the like.

With reference to FIG. 12, an embodiment of medication injection site tracking is flowcharted. In a step or software module 280, a display figure representative of a body with prior injection sites indicated is constructed. The body represents a patient in a human body frontal outline and injection sites are indicated on the outline relative to the body with one or more icons, such as circles. Each injection site is labeled to indicate a time of the prior injection site. The constructed display is displayed on the display device 214 in a step or software module 282.

In a decision step or software module 284, input is received of a new injection site. The step includes receiving a location of the new site using the human figure, e.g. drag and drop operation. The new site is recorded in a step or software module 286. The recording includes recording a time of medication administration or the injection. The step includes storing and/or forwarding the recorded injection locally and/or at the system level, e.g. recording in the patient's medical record.

With reference to FIG. 13, an embodiment of site instruction is flowcharted. In a step or software module 290, site instructions are received for a test, procedure, medication, or protocol and a display is configured with site instructions. The site instructions include site policies and instructions to perform the test, procedure, medication administration, or protocol. The instructions can include written instructions, photographs, illustrations, video, and the like. The configured display is displayed by the display device in a step or software module 292.

In a decision step or software module 294, input is received to operate a video which delivers the instruction to perform the scheduled task. In a step or software module 296, the video is played or streamed to deliver the instruction using the display device.

In another embodiment, with reference to FIG. 14, patient information 301 is collected and sent to computing device 305. Although patient information 301 may be collected in a neonatal intensive care unit (NICU), it is to be appreciated that this embodiment is also applicable to other care units. In an embodiment related to an NICU, the patient information 301 may include representations of, for example, digestive system, skeleton, brain, hemodynamic, nervous system, and ventilation information. In an embodiment related to a Cardiovascular Care Unit, the patient information 301 may include representations of, for example, heart rate, blood pressure, breathing and so forth. The computing device 305 includes display component 303. A caregiver may login to computing device 305 thereby providing caregiver information to the computing device 305. The display device 303 can display all of a group of patients that have been entrusted to the caregiver. Additionally, this aspect provides a workflow for the caregiver that adapts to the patient's need. For example, the information displayed on the display device 303 updates automatically (e.g. by removing a completed task or rescheduling a task based on new information) based on changes regarding the status or occupancy of the patient.

With reference to FIG. 15, in operation 310, caregiver login information can be received by the computing device 305. In operation 320, the computing device 305 can receive patient information. In operation 330, an identification information section is calculated and displayed. In operation 340, a workload section is calculated and displayed. In operation 350, a patient vital sign section is calculated and displayed. In operation 360, a patient timeline section is calculated and displayed. In operation 370, additional information is calculated and displayed. It will be appreciated that the operations of FIG. 15 may be performed in different orders and that many of the operations are optional.

The display component 303 depicted in FIG. 14 can display information in various ways; one aspect of this is shown in FIG. 16. With continuing reference to FIG. 16, caregiver information can be displayed in a caregiver section 401. The caregiver section 401 includes both a caregiver identification information section 403 and a workload section 405. The caregiver identification information section is preferably in an upper left portion of the display component 303 and includes a caregiver name, picture and other information (e.g. “doctor,” “nurse” etc.). The workload section 405 is preferably placed in upper center and upper right portions of display component 303 and shows a workload status or a workload time line of the caregiver. The workload status or workload timeline can be color-coded to provide an indication of workload (e.g. green may represent a light workload; red a heavy workload). Additionally, a higher line may indicate a heavier workload and a lower line may indicate a lighter workload. The caregiver may use the above-described features to know when to ask for help. Along with this, in one aspect, an alarm button is provided to the caregiver which may be used, for example, to reschedule tasks. That way, another caregiver may take on a task or tasks that were assigned to a caregiver with too heavy a workload.

With continuing reference to FIG. 16, patient information is preferably displayed in a patient section 411 beneath the caregiver section 401. The patient section 411 includes both a patient vital sign section 413 and a patient timeline section 415. The patient vital sign section 411 is preferably on the left-hand side of the display, and preferably includes information such as the patient's name, date of birth, and age. The patient information section 411 may further include vital sign information such as digestive system (DI), skeleton (SK), brain (BR), hemodynamic (HE), nervous system (VE), and ventilation information (SE). An example of vital sign information is shown in greater detail in FIG. 18. The vital sign information in this embodiment is depicted in a generally circular shape or descriptive ring 421 and can be color-coded (e.g. green indicates that a vital sign is in good condition; yellow indicates an acceptable condition; red indicates bad condition). Furthermore, the descriptive ring 421 is divided into ring portions 423, each ring portion 423 representing a vital sign, e.g., a state of the DI, SK, BN, HE, VE, or SE. And, a thickness, a radial shift, and/or colors indicates the condition (e.g. good, warning, bad) of each depicted vital sign (e.g. a thin line may indicate a vital sign is in good condition; a thick line may indicate that a vital sign is in bad condition; a line closer to the center of the descriptive ring 421 may indicate a vital sign is in good condition; a line farther away may indicate a vital sign is in bad condition).

With further reference to FIG. 16, patient timeline section 415 includes individual patient timelines (FIG. 17 shows an example of patient timeline 431). Preferably, information corresponding to one patient including a patient timeline 431 and descriptive ring 421 are displayed in the same horizontal plane. The patient timeline 431 includes a thin line showing the progression of time with events depicted on thick lines 433. Examples of events include a visitation by a parent, a checkup by a doctor, and a time to administer nutrition to an infant. Events on the thick lines 433 are preferably color-coded and thickness-coded to show, for example, the importance of the event. The timeline 431 includes a description, estimated start time and estimated time duration of the event. Events may be planed so that they do not interfere with other events. For example, an event may be planned or rescheduled based on if an infant is asleep or based on an infant's anticipated sleep schedule. All of the events planned for a patient during a particular time duration (e.g. two hours) may be displayed. Furthermore, a time duration for each event is preferably displayed. Additionally, each event can include one or more tasks. Task information (e.g. a task time duration and task description) is preferably displayed. Alternatively, the above-described information may be displayed in the form of an analog clock face.

With reference to FIG. 19, in one aspect, toggle button section 501 is shown. Preferably displayed on the bottom of the display component 303, toggle buttons can be used to turn on/off different features, and control what information is displayed. Turning off certain features can help to de-clutter the screen and may make it easier for the caregiver to see what upcoming tasks are at hand. Turning on more features may provide a better overview, and may provide more information. Examples of toggle buttons include sleep, kangaroo care, eating/drinking, visitors, treatment and check.

FIG. 20 shows an additional example of aspects of the display component 303.

The computing device 305 and display component 303 are particularly useful in the context of NICU applications. This is because infants need to be closely monitored, and because often a single caregiver is entrusted to oversee multiple NICUs. However, the devices described herein have applications more broadly to healthcare generally, and are not to be construed as being limited to NICU contexts.

It is to be appreciated that in connection with the particular illustrative embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof. That is to say, it will be appreciated that various of the above-disclosed and other features and functions, or alternatives thereof, may be desirably combined into many other different systems or applications, and also that various presently unforeseen or unanticipated alternatives, modifications, variations or improvements therein may be subsequently made by those skilled in the art which are similarly intended to be encompassed by the following claims.

1. A computing device comprising:
an analog clock device configured to generate an analog clock face including concentric circles and task icons, each concentric circle including arranged icons of a selected task type;
a shift timer device configured to identify a selected time window on the analog clock face;
a display device configured to display the generated analog clock face; and
a dimension device configured to organize the tasks by task type which includes at least one of:
medical tests;
medications;
medical procedures;
a protocol;
high priority task notification; and
late task notification.

2. (canceled)

3. The computing device according to claim 1, further including:
a scope device configured to retrieve the tasks according to the identified time window and based on one of a doctor order, a patient medical record, a patient emergency medical record, a protocol or at least one patient.

4-6. (canceled)

7. The computing device according to claim 1, further including at least one of:
a task representation device configured to select icons according to task type and quantity of tasks represented;
a medication device configured to construct a display representation of a body with at least one prior injection site indicated, the display device being further configured to display the constructed display representation of a body with the at least one prior injection site indicated; and
at least one input device configured to receive an indication from a healthcare practitioner of a new injection site, the medication device being further configured to record the new injection site and time of injection.

8-9. (canceled)

10. The computing device according to claim 1, further including:
a site instruction device configured to receive site instructions for at least one of a test, procedure, or medication and configure a display which includes the received site instructions; and
a display device which displays the configured display which includes the received site instructions.

11. A method of organizing and rescheduling tasks, comprising:
generating an analog clock face including concentric circles and task icons, each concentric circle including arranged icons of a selected task type;
identifying a selected time window on the analog clock face; and
organizing tasks by task type which includes at least one of:
medical tests;
medications; and
medical procedures; and
displaying the generated analog clock face.

12. The method of organizing tasks according to claim 11, wherein the identified time window includes at least one of:
a range of up to 11 hours historical;
a future interval; or
a dynamic interval which changes with current time.

13. The method of organizing tasks according to claim 11, further including:
retrieving tasks according to the identified time window and based on at least one patient based on one of a doctor order, a patient medical record, a patient emergency medical record, or a protocol.

14. (canceled)

15. The method of organizing tasks according to claim 11, further including at least one of:
selecting icons according to task type and quantity of tasks represented;
constructing a display representation of a body with at least one prior injection site indicated;
displaying the constructed display representation of a body with the at least one prior injection site indicated;
receiving site instructions for at least one of a test, procedure, or medication and configure a display which includes the received site instructions; and
displaying the configured display which includes the received site instructions.

16-28. (canceled)

29. The method of organizing and rescheduling tasks according to claim 11, further comprising:
displaying a caregiver section comprising an identification information section and a workload section; and
displaying a patient section comprising a patient vital sign section and a patient timeline section,
wherein the patient timeline section includes a timeline for each patient and events are marked by a color-coded line on each timeline; and
wherein an event time duration information and number of tasks information for each event is displayed on the timeline; and for each task within an event, a task time duration and a task name information is displayed.

30. The method of organizing and rescheduling tasks according to claim 29, wherein the vital sign section includes:
a vital sign descriptive ring including at least one ring portion; and
wherein each ring portion corresponds to a patient vital sign.

31-34. (canceled)

35. The method of organizing and rescheduling tasks according to claim 29, wherein the patient timeline section includes:
a thin horizontal line; and
wherein an event on the timeline is represented by a thickness-coded, color-coded line.

36. (canceled)

37. The method of organizing and rescheduling tasks according to claim 29, wherein patient vital sign information is displayed as a generally circular shape with different sections corresponding to different vital signs.

38. The method of organizing and rescheduling tasks according to claim 29, wherein:
information sent from an infant care unit represents at least one of: digestive system, skeleton, brain, hemodynamic, nervous system, and ventilation information of an infant; and
the information is received by a computing device.

39-40. (canceled)

41. The computing device according to claim 1, further comprising:
one or more processors configured to:
identify a time window which includes a time duration of at least one work shift;
receive tasks corresponding to one or more patients and the identified time window;
organize the received tasks according to medical task type which includes at least one of tests, medications, or procedures;
select icons for each organized task according to the task type and quantity of tasks within a predetermined time period; and
a display device configured to display at least one of:
the selected icons in concentric circles of an analog clock face; or
a caregiver section comprising an identification information section and a workload section; and a patient section comprising a patient vital sign section and a patient timeline section, the patient timeline section including a timeline for each patient in which events are marked by a color-coding;
wherein an event time duration information and number of tasks information for each event being displayed on the timeline; and for each task within an event, a task time duration and a task name information is displayed.

42. The computing device according to claim 41, wherein at least one of:
the computing device comprises a device configured for rescheduling an adaptive, patient-centric workflow;
the vital sign section includes: a vital sign descriptive ring including at least one ring portion, each ring portion corresponding to a patient vital sign;
the patient timeline section includes a thin horizontal line; and
an event on the timeline is represented by a thickness-coded, color-coded line.
